(19) United States
(12) Patent Application Publication
(10) Pub. No.: US 2026/0343695 A1
(43) Pub. Date: Oct. 29, 2026

(54) SHARPER PATTERNED ILLUMINATION ADDING BACKGROUND

(71) Applicant: Lumileds LLC, San Jose, CA (US)

(72) Inventors: Marcus Hendrikus Adrianus van Steen, Eindhoven (NL); Mehdi Aas, Eindhoven (NL)

(21) Appl. No.: 19/487,950

(22) PCT Filed: May 17, 2024
(86) PCT No.: PCT/US2024/029843

§ 371 Date: Nov. 25, 2025

Related U.S. Application Data
(60) Provisional application No. 63/469,954, filed on May 31, 2023.

(51) Int. Cl. H05B 45/10; H05B 47/175

(52) U.S. Cl. CPC H05B 45/10; H05B 47/196

(57) ABSTRACT

An illumination system and method of enhancing contrast are described. A light emitting diode (LED) array is controlled to provide a substantially constant background illumination over an area other than a target area prior to adjusting driving of LEDs in the LED array. The constant background illumination is obtained by driving the associated LEDs using a non-zero driving current substantially less than that used to drive LEDs associated with the target area. Once an area of enhanced contrast is determined, the LEDs providing illumination to the enhanced contrast area are no longer driven, while driving of the other LEDs remains constant.

### PRIORITY CLAIM

This application claims the benefit of priority to U.S. Provisional Patent Application Ser. No. 63/469,954, filed May 31, 2023, which is incorporated herein by reference in its entirety.

### FIELD OF THE DISCLOSURE

The present disclosure relates to illumination of areas. In particular, embodiments are directed to control of luminaires containing light emitting diode (LED) arrays at illuminate overlapping areas.

### BACKGROUND OF THE DISCLOSURE

Luminaires and other lighting devices are used for illumination in a variety of venues, including both indoor and outdoor areas. A typical example in which multiple luminaires are used is a larger room, such as a conference area. Optimal illumination of a room, which may include a mix of direct and indirect light, may be dependent on the use case. Depending on the use, the optimal distribution, direction, and/or spectrum of the light from the individual light sources may differ.

### BRIEF DESCRIPTION OF THE DRAWINGS

FIG. 1 shows a lighting system, in accordance with some examples.

FIG. 2 illustrates an example of a general lighting device in accordance with some embodiments.

FIG. 3 illustrates an example of a method of controlling a lighting system in accordance with some embodiments.

FIGS. 4A-4D illustrate examples of top views of target area illumination in accordance with some embodiments.

FIGS. 4E-4F illustrate examples of graphs of a cross-section of the top views of the target area illumination of FIGS. 4A-4D in accordance with some embodiments.

FIG. 5 illustrates an example lighting system, according to some embodiments.

FIG. 6 illustrates an example lighting device, according to some embodiments.

FIG. 7 illustrates a top plan view of an example array suitable for implementing embodiments described herein.

FIG. 8 illustrates a cross-section of an LED in an LED array, in accordance with some examples.

### DETAILED DESCRIPTION

Providing optimized lighting conditions may differ dependent on the area being illuminated, the external environmental conditions, and the use within a particular area, among others. Optimal (or near optimized) lighting conditions may be determined based on proximity to achieving a specified lighting pattern having predetermined parameters. In some cases, the optimized lighting conditions may be provided by modifying the target area with a contrast enhanced pattern as described in more detail below.

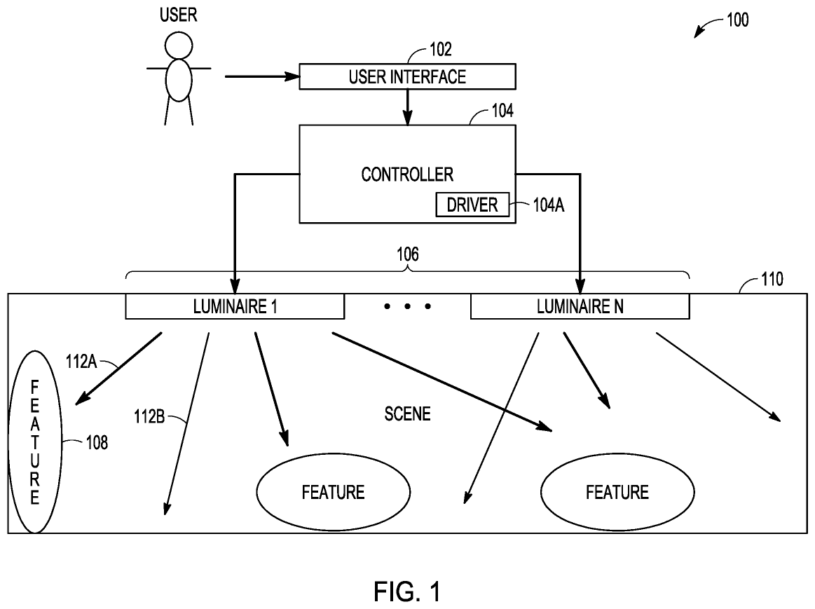

FIG. 1 shows a lighting system 100, in accordance with some examples. The lighting system 100 includes multiple luminaires 106 (or other lighting device) disposed within a room 110. The luminaires 106 may contain one or more LED arrays whose LEDs may be controlled individually (e.g., segmented LEDs) or in sets of LEDs. The luminaires 106 may be disposed on the ceiling of the room 110 as shown in FIG. 1 and may, through optics of and/or external to the luminaires 106 project light onto surfaces in the room 110. In other embodiments, the luminaires 106 or LED arrays may be disposed on other surfaces in the room 110, such as sconces on walls, and may perhaps be encased in fixtures or objects such as furniture. In some embodiments, the luminaires 106 may be stationary, while in other embodiments the luminaires 106 may be movable (e.g., track lighting or in a lamp). In either case, the light from (and perhaps location of) the luminaires 106 may be controllable in intensity and, in some embodiments, directionality and/or focal point.

Each of the LEDs may be formed from one or more inorganic materials (e.g., binary compounds such as gallium nitride (GaN) or gallium arsenide (GaAs), ternary compounds such as aluminum gallium arsenide (AlGaAs), quaternary compounds such as indium gallium phosphide (InGaAsP), or other suitable materials), usually either III-V materials (defined by columns of the Periodic Table) or II-VI materials. Each of the LEDs may emit light in the visible spectrum (about 400 nm to about 800 nm). In some embodiments, one or more other layers, such as a phosphor layer may be disposed on each of the one or more LED arrays to convert the light from the LEDs into white (or another color) light.

In some embodiments, at least some of the LEDs of one or more of the luminaires 106 may emit light of different wavelengths. In this case, LEDs that emit light in the different wavelengths may be formed in different LED arrays. Each of the LEDs may be controllable by one or more processors. Example array may include, for example, 7×7 independently controllable segments, although other array sizes and shapes may be used.

The LEDs in each array may be microLEDs or may be miniLEDs, for example. A microLED array may include thousands to millions of microscopic LEDs that may emit light and that may be individually controlled or controlled in groups of pixels (e.g., 5×5 groups of pixels). MicroLEDs are small (e.g., <0.01 mm on a side) and may provide monochromatic or multi-chromatic light, typically red, green, blue, or yellow using inorganic semiconductor material such as that indicated above. Each luminaire 106 in FIG. 1 may include one or more LED arrays, of which each LED array may be of one or more types (e.g., microLEDs or miniLEDs). Different luminaires 106 may contain the same configuration of one or more LED arrays or may contain different configurations of one or more LED arrays.

The luminaires 106 may include at least one lens and/or other optical elements such as reflectors. The lens and/or other optical elements may direct the light emitted by the one or more LED arrays towards one or more features 108 or locations to be illuminated (also referred to herein as target areas). Each LED array, each LED in the LED array, and/or each set of a plurality of sets of LEDs in the LED array may have light emitted therefrom directed by the lens and/or other optical elements. As shown in FIG. 1, the luminaires 106 may emit light in multiple directions. In some embodiments, each LED in one of the LED arrays within a particular luminaire 106 may be shaped by the lens and/or other optical elements to propagate in a particular direction, and the light from different LED arrays within the luminaire 106 may propagate in the same direction or one or more different directions (e.g., based on the optics). In some embodiments, light from one or more of the LED arrays in each luminaire 106 may overlap the light from one or more of the LED arrays in a different luminaire 106. In other embodiments, the light from the LED arrays in each luminaire 106 may not overlap the light from the LED arrays in a different luminaire 106.

In some embodiments, the lighting system 100 may be steerable and may provide optimized illumination with no moving parts by projecting the light from luminaires 106. While in some cases the light distribution, spectrum, and direction in such a system may be controlled solely by changing the currents through (i.e., driving) individual LEDs within the luminaire 106 illuminating a particular feature 108 or features within the room 110, limiting driving of these LEDs alone may not allow for optimized illumination. Note that the driving may include analog and/or digital control of the current supplied to each LED or set of LEDs. A feature 108 may be, for example, an area in which an individual might occupy or a particular area of a table within the room 110; such an area is alternately referred to herein as a target area.

The luminaires 106 may be manipulated using a controller 104, which may include one or more processors. The controller 104, in turn, may be programmed to control the luminaires 106 to provide default illumination in the room 110. The default illumination of a particular feature 108 may be adjusted automatically, e.g., based on a sensor within the room 110 configured to detect an individual or object at the particular feature 108. The sensor, for example, may be a facial detection sensor configured to detect any (or a particular) face at or near the particular feature 108. Alternatively, or in addition, the controller 104 may be controlled by a user using a user interface 102. The user interface 102 may be fixed within the room 110, or may be a remote device, such as a specialized controller or an app for a mobile phone, for example.

As shown in FIG. 1, a single controller 104 that controls the luminaires 106 may be separate from the luminaires 106. In other embodiments, the controller 104 or controllers may be disposed within one (or each) of the luminaires 106 or may be separate from the luminaires 106 and may be present inside of the room 110 and/or outside of the room 110. In some embodiments, multiple controllers 104 may be present and may provide control of some or all of the luminaires 106. In this case, at least one controller 104 may overlap control provided by at least one other controller 104 (i.e., some or all of the luminaires 106 controlled by another controller 104) or each controller 104 may control one or more entirely different luminaires 106 than each other controller 104.

In some embodiments, the controller 104 may include at least one driver 104a to drive the LEDs. The driver 104a may be an analog driver that applies, for example, an analog current to the LEDs or pulse width modulation (PWM) driver that applies PWM signals having a controllable duty cycle to the LEDs. In other embodiments, the driver 104a may disposed in one or more of the luminaires 106 in addition to, or instead of, the controller 104.

As shown in FIG. 1, the controller 104 may control the LED array(s) in the luminaire 106 through a physical signal line or wirelessly to provide different amounts of illumination to different areas of the room 110. The luminaire 106 may thus have a power connection and data interface. In particular, as discussed in more detail below, light 112a having a relatively higher intensity may be provided to illuminate the features 108 than other light 112b illuminating other areas of the room 110. Each of the luminaires 106 may illuminate one or more features 108 using the higher intensity light 112a. As above, each of the luminaires 106 may illuminate one or more of the same features 108 as another of the luminaires 106 or may illuminate entirely different features 108 as each other of the luminaires 106. Each of the luminaires 106 may illuminate the same, or a different, number of features 108 as another of the luminaires 106. In addition, different colors or color temperatures may be used to illuminate the features 108, with each color being provided by an LED array from one or more of the luminaires 106. The intensity, color temperature, and other characteristics of the light from the luminaires 106 may be set by the user through the user interface 102.

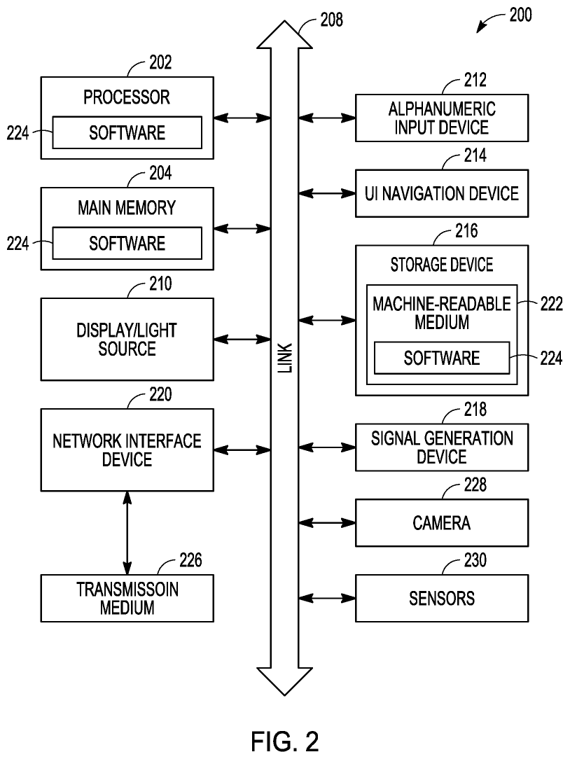

FIG. 2 illustrates an example of a lighting device 200 in accordance with some embodiments. The lighting device 200 may be a mobile device such as a laptop computer (PC), a tablet PC, or a smart phone, a luminaire, or an automotive device, for example. Various elements may be provided on the backplane indicated above, while other elements may be local or remote. Examples, as described herein, may include, or may operate on, logic or a number of components, modules, or mechanisms.

Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations. In some embodiments, not all of the components shown in FIG. 2 may be present.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The lighting device 200 may include a hardware processor (or equivalently processing circuitry) 202 (e.g., a central processing unit (CPU), a GPU, a hardware processor core, or any combination thereof), a memory 204 (which may include main and static memory), some or all of which may communicate with each other via an interlink (e.g., bus) 208. The memory 204 may contain any or all of removable storage and non-removable storage, volatile memory or non-volatile memory. The lighting device 200 may further include a display/light source 210 such as the LEDs described above, or a video display, an alphanumeric input device 212 (e.g., a keyboard), and a user interface (UI) navigation device 214 (e.g., a mouse). In an example, the display/light source 210, input device 212 and UI navigation device 214 may be a touch screen display. The lighting device 200 may additionally include a storage device (e.g., drive unit) 216, a signal generation device 218 (e.g., a speaker), a network interface device 220, one or more cameras 228, and one or more sensors 230, such as a global positioning system (GPS) sensor, compass, accelerometer, or other sensor such as those described herein. The lighting device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, completely or at least partially, within the memory 204 and/or within the hardware processor 202 during execution thereof by the lighting device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the lighting device 200 and that cause the lighting device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.) or the SPI or CAN bus. Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.12.4 family of standards, a Long Term Evolution (LTE) family of standards, a Universal Mobile Telecommunications System (UMTS) family of standards, peer-to-peer (P2P) networks, next generation (NG)/5th generation (5G)/6th generation (6G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

The camera 228 may sense light at least the wavelength or wavelengths emitted by the LEDs. The camera 228 may include optics (e.g., at least one camera lens) that are able to collect reflected light of illumination that is reflected from and/or emitted by an illuminated region. The camera lens may direct the reflected light onto a multi-pixel sensor (also referred to as a light sensor) to form an image of on the multi-pixel sensor.

The processor 202 may control and drive the LEDs via one or more drivers. For example, the processor 202 may optionally control one or more LEDs in LED arrays independent of another one or more LEDs in the LED arrays, so as to illuminate an area in a specified manner.

In addition, the sensors 230 may be incorporated in the camera 228 and/or the light source 210. The sensors 230 may sense visible and/or infrared light. The sensors may have one or more segments (that are able to sense the same wavelength/range of wavelengths or different wavelength/range of wavelengths), similar to the LED arrays of the light source 210.

As above, the lighting system 100 of FIG. 1 is a steerable lighting system. However, one of the issues of a practical implementation of a steerable lighting system is optical crosstalk between LEDs in an LED array. Due to such crosstalk, not only is the area associated with a particular LED illuminated when the particular LED is driven, but also the neighboring area is illuminated. In various embodiments, between about 20-70% of the light from a particular LED (or pixel) may be imaged, while the remaining light may be diffused. This variation may depend on the pixel location within the luminaire due to, for example, angle of the light from the LED with respect to a target area when passing through a diffuser, such as polycarbonate. Additionally, in situations in which the LEDs (and thus luminaire) provide light of different colors to allow the luminaire to be color tunable, this effect may be wavelength dependent and thus may be exacerbated. The practical effect of this is that while a beam steerable pixilated luminaire may be programmed to generate one or more ideal target areas, the outcome is a pattern with blurred edges.

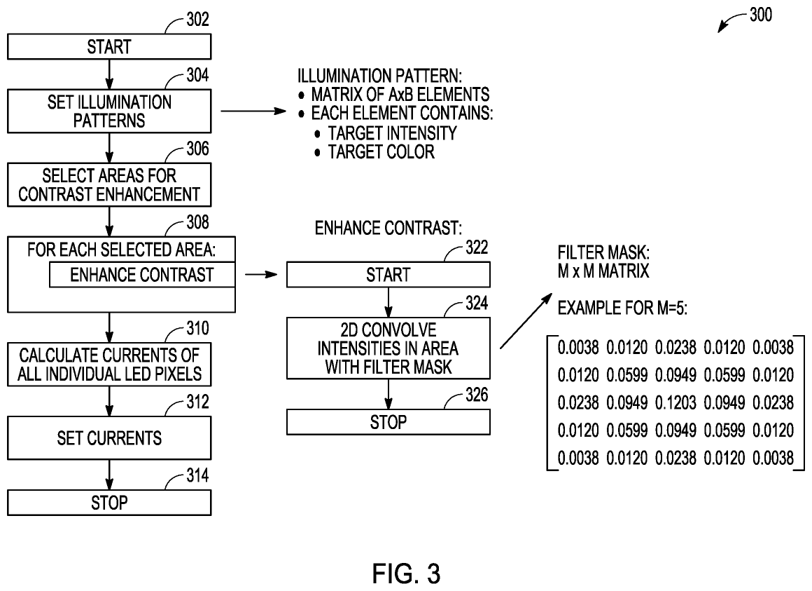

FIG. 3 illustrates an example of a method 300 of controlling a lighting system in accordance with some embodiments, described in more detail below.

The exemplary method 300 of FIG. 3 is used to control illumination of a lighting system, such as that shown in FIG. 1. After the start 302 of the method 300, one or more processors in the controller set the illumination pattern at operation 304. A default illumination pattern may be preprogrammed into the controller and may be adjusted by a user using the user interface. The user interface may provide, for example, a visual map of the room and allow the size, illumination intensity, and color temperature, among others, of the target area to be adjusted, e.g., through a graphical user interface (GUI). The illumination pattern stored in, and used by, the controller may thus include a matrix of elements that include one or both the intensity and color to be displayed at the area defined by each element (LED or set of LEDs in the LED array). The illumination pattern may cover an area that includes not only the target area, but also a transition area (that is not to be illuminated) around the target area and a background area (that is to be illuminated by light of a uniform background illumination). Each element may be associated with illumination for only one of the target area, the transition area, or the background area and may be represented by illumination provided from one or more LEDs of one or more LED arrays of one or more luminaires.

At operation 306, the one or more processors selects one or more particular areas for contrast enhancement. One such area may include the transition area around the target area.

At operation 308, the one or more processors may enhance the contrast for each selected area. This may include, for each selected area as shown in FIG. 3, the one or more processors starting 322 the contrast enhancement at operation 324 by convolving intensities in the selected area with a filter mask before stopping 326. The convolution may be a two-dimensional (2D) convolution in which the element array and filter mask may each be a 2D matrix. The matrices may not have the same number of elements, e.g., as shown the element matrix is an A×B matrix and the filter mask is an M×M matrix. The number and shape of the matrix in each luminaire may be identical or at least one the number and/or shape of at least one matrix in at least one luminaire may be different from that of at least one other matrix in at least one other luminaire.

The convolution may set only the intensity to be provided to the various areas, which may result in values used to determine the currents of each LED in each luminaire at operation 310. Once the currents are determined based on the intensity so determined, the controller may set the currents at operation 312 for one or more drivers to drive the individual LEDs before stopping 314.

To set the currents, the illuminance contribution of each LED in each LED array in the lighting system may be recorded (e.g., using a camera) at each location to create a map of the flux value of each element for a given target area light distribution. The illuminance at a surface is a linear combination of the illuminance from all light sources incident on that surface. Therefore, for a lighting system with n array elements, the illuminance Eₛ at a sample surface s can be written as:

Eₛ=aₛ₁x₁+aₛ₂x₂+ . . . +aₛₙxₙ
where aₛₜ is the illuminance at surface s due to array element t at nominal power, and xₜ is the relative flux of array element t. With m sample points, this can be written as a matrix equation:

$$[ \begin{matrix}{E}_{1} \\ ⋮ \\ {E}_{m}\end{matrix} ] = [ \begin{matrix}{a}_{11} & … & {a}_{1 n} \\ ⋮ & ⋱ & ⋮ \\ {a}_{m 1} & … & {a}_{mn}\end{matrix} ] [ \begin{matrix}{x}_{1} \\ ⋮ \\ {x}_{n}\end{matrix} ]$$

or in matrix notation:

E=A·x

A set of m illuminance sample points is defined in the space and the illuminance contribution of each of the n array elements at each of the sample points is determined. The photometric quantities of each of the n array elements recorded may include illuminance, color, and spectrum. The illuminance and photometric qualities may be determined using one or more sensors positioned in each location to record the desired information.

Based on the recorded information, the flux values for the array elements are calculated. The optimal (or near optimal or desired) flux values are calculated for each of the array elements for achieving the desired lighting design. The calculated flux values are translated to their corresponding electrical power parameters (current and/or PWM duty cycle) and stored in the controller.

When the number of sample points m equals the number of array elements n, matrix A is square and calculation of the vector x may be performed through a simple matrix inversion. However, this may produce a vector x with elements outside the 0-1 range, meaning the solution cannot be physically represented with the lighting system. Another solution is therefore to use a least-squares fitting algorithm with the constraint that all parameters are in the 0-1 range. Such algorithms are known as non-negative least-squares (NNLS) algorithms and implementations are readily available in many programming languages.

Generally, the matrix A may be other than square, but for an effective solution it is desirable that m and n are similar in magnitude (m<<n is an underdetermined problem that may lead to undesirable/unintended lighting distributions, while m>>n may increase calculation time without improving the result). Additional constraints may be readily added to the NNLS algorithm. For example, an upper or lower bound may be placed on the illuminance at some of the sample points to ensure the found solution is within those bounds. Other constraints may be that energy consumption of the system (or a particular luminaire) is minimized, or that the total power of the system (or a particular luminaire) stays below the power rating of the lighting system. It is also possible to apply weighting factors in NNLS algorithms, for example if meeting a target area lighting distribution is preferred in some areas more than others.

For a color-tunable lighting system, the matrix equation may be set up in similar way but with a larger matrix capturing the additional degrees of freedom provided by the color tuning. For example, for a system with three primary colors (e.g., R, G and B) that are each segmented into n elements, the matrix equation is:

$$[ \begin{matrix}{X}_{1} \\ ⋮ \\ {X}_{m} \\ {Y}_{1} \\ ⋮ \\ {Y}_{m} \\ {Z}_{1} \\ ⋮ \\ {Z}_{m}\end{matrix} ] = [ \begin{matrix}{a}_{R 1 X 1} & … & {a}_{RnX 1} & {a}_{G 1 X 1} & … & {a}_{GnX 1} & {a}_{B 1 X 1} & … & {a}_{BnX 1} \\ ⋮ & ⋱ & ⋮ & ⋮ & ⋱ & ⋮ & ⋮ & ⋱ & ⋮ \\ {a}_{R 1 Xm} & … & {a}_{RnXm} & {a}_{G 1 Xm} & … & {a}_{G nXm} & {a}_{B 1 Xm} & … & {a}_{BnXm} \\ {a}_{R 1 Y 1} & … & {a}_{RnY 1} & {a}_{G 1 Y 1} & … & {a}_{GnY 1} & {a}_{B 1 Y 1} & … & {a}_{BnY 1} \\ ⋮ & ⋱ & ⋮ & ⋮ & ⋱ & ⋮ & ⋮ & ⋱ & ⋮ \\ {a}_{R 1 Ym} & … & {a}_{RnYm} & {a}_{G 1 Ym} & … & {a}_{GnYm} & {a}_{B 1 Ym} & … & {a}_{BnYm} \\ {a}_{R 1 Z 1} & … & {a}_{RnZ 1} & {a}_{G 1 Z 1} & … & {a}_{GnZ 1} & {a}_{B 1 Z 1} & … & {a}_{BnX 1} \\ ⋮ & ⋱ & ⋮ & ⋮ & ⋱ & ⋮ & ⋮ & ⋱ & ⋮ \\ {a}_{R 1 Zm} & … & {a}_{RnZm} & {a}_{G 1 Zm} & … & {a}_{GnZm} & {a}_{B 1 Zm} & … & {a}_{BnXm}\end{matrix} ] [ \begin{matrix}{R}_{1} \\ ⋮ \\ {R}_{n} \\ {G}_{1} \\ ⋮ \\ {G}_{n} \\ {B}_{1} \\ ⋮ \\ {B}_{n}\end{matrix} ] .$$

Here, the illuminance vector E comprises the target area illuminance and target area color expressed in any three-dimensional color space, for example XYZ tristimulus values. In this case, the solution vector x comprises the relative flux values of all n elements of the three primaries R, G and B.

Although convolution is described, the contrast may be enhanced in other embodiments using methods other than convolution. For example, a Fast Fourier Transform (FFT) output based on the illumination may be subjected to high pass filtering and the inverse FFT may then be calculated to determine the values of the LEDs to be used for the enhancement in the transition area. Alternatively, or in addition, the high pass filter may be implemented using a 2D Infinite Impulse Response (IIR) high pass filter. Similarly, alternatively, or in addition, nonlinear algorithms may be used to implement the high pass filter. The nonlinear algorithms may include edge detection using thresholding, or artificial neural networks trained to detect edges (of the target area) for enhancement in the transition area.

In embodiments in which convolution is used, linear operation of convolution, and other linear transforms, may be combined with nonlinear calculation steps such as the above thresholding to provide the desired enhancements.

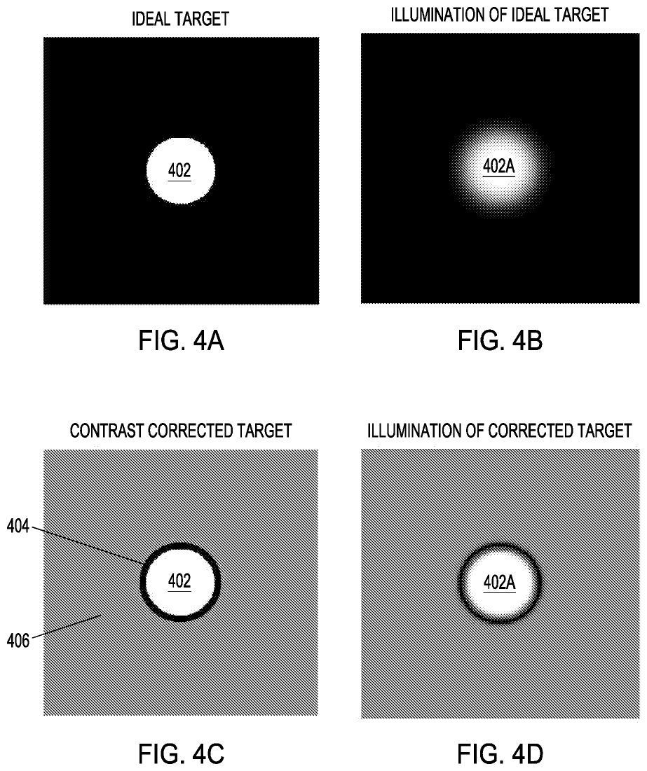

FIGS. 4A-4D illustrate examples of top views of target area illumination in accordance with some embodiments. FIGS. 4E-4F illustrate examples of graphs of a cross-section of the top views of the target area illumination of FIGS. 4A-4D in accordance with some embodiments. As best seen in FIGS. 4A and 4B, which show an example of an ideal target area 402 in FIG. 4A and illumination 402a of the ideal target area in FIG. 4B, the illumination 402a of the target area is a blurry pattern. FIG. 4E illustrates a graph of the illumination within the area shown in FIGS. 4A and 4B, with the y axis showing intensity in arbitrary units and the x axis showing distance in arbitrary units. As can be seen, in FIGS. 4E and 4F, although the ideal target area illumination shown in FIG. 4A and FIG. 4E has no intensity outside the target area and the target area ranging from 150-250 units is illuminated at a desired (e.g., maximum) intensity (essentially a delta function in intensity), in reality there is a transition distance of the illumination. This transition shown in FIG. 4B and FIG. 4F extends between about 125 units and 175 units and between about 225 units and about 275 units, so that the desired intensity is reached over a much smaller area than the ideal case.

Instead, to provide an output pattern of the luminaire that is closer to the ideal target area, the illumination of the target area may be modified using a contrast enhanced pattern. Instead of attempting to drive only a predetermined set of LEDs to achieve illumination of a desired target area (and thus the current driving the other LEDs being set to 0 or another predetermined current), most of the LEDs other than those of the predetermined set of LEDs may be driven at a substantially reduced (non-zero) current (e.g., the predetermined current); the remaining LEDs are not driven. This is the case for each luminaire illuminating the target area. For example, the LEDs driven at the reduced current may be driven at a current of less than about 20% of the current used to drive the predetermined set of LEDs. This range of current may vary, e.g., less than about 15%, less than about 10%, less than about 5%. Current that is substantially less may provide illumination in a range from about 1% to about 20% of that of the target area, dependent, for example, on characteristics of the room (e.g., amount of ambient light, reflective surfaces, etc.). In other embodiments, any subset of this range may be used, such as about 1% to about 15%, about 1% to about 10%, about 1% to about 5%, etc. Note that there is a minimum, non-zero, current provided to these LEDs and thus non-zero illumination provided by these LEDs. The LEDs that are not driven may be disposed between the predetermined set of LEDs and the LEDs driven at the reduced current. Note that the term “about x” and similar terms (e.g., substantially) as used herein may be understood to be within 10% of x or otherwise within a range known to one of skill in the art to be within tolerance of the quantity or quality described unless indicated otherwise. In some embodiments, one or more processors and one or more light sensors (photodiode arrays) both in one or more luminaires may be used to determine the desired background illumination (and thus driving) based on detecting the ambient illumination and illumination under different lighting conditions (one or more of the luminaires under different driving conditions).

Thus, rather than complete darkness (no illumination being provided), in one situation a room may be illuminated evenly at a low background level to provide a sufficient amount of illumination to allow an overview of the room and comfort level to traverse the room (e.g., about 10-20 lumens per square foot). In some embodiments, one or more processors that are in one or more luminaires may be used to determine the desired background illumination. The features may be highlighted as desired either using an initial (default) set of highlights or as selected by a user. However, the boundaries of the features may not be very distinct, so the features may not really stand out that much. In the contrast enhanced situation, the illumination of the areas adjacent to (e.g., around) the features may be reduced to be as dark as possible, and the other illumination may remain the same (i.e., to provide the low background level). Areas that are adjacent to other areas, as used herein, abut the other areas. Such areas may partially or entirely surround the other areas in various embodiments. The visual effect of such an embodiment is that individuals within the room may thus be able to distinguish the features much easier from the background.

As shown in FIGS. 4C and 4D, the illumination 404 provided by the LEDs that are not driven may be less than the illumination 406 of the LEDs driven at the reduced current, which in turn is less than the illumination of the target area 402 of the predetermined set of LEDs. Thus, the LEDs driven at the reduced current may produce a diffused (non-localized) background illumination level. In this case, even though the LEDs that are not driven may produce a low amount of illumination, the perceived sharpness may be enhanced as a penumbra of low illumination around the area of illumination provided by the predetermined set of LEDs may be lower than that of the background illumination provided by the LEDs driven at the reduced current.

This sharpness is shown in FIGS. 4E and 4F. In particular, in FIG. 4E the ideal target area illumination has no intensity immediately outside the target area and background illumination farther from the target area. This is similar to FIG. 4F, in which the illumination area between the background and the target area, while not being dark, dips to significantly less than (e.g., as shown about half illumination level) that of the background before more abruptly transitioning to the target area. The output from the contrast enhanced pattern as shown in FIG. 4F has sharper edges.

Note that while this is described as being used in a room, such as in an office environment, the illumination system may be used in other embodiments. These environments may include industrial environments, e.g., for use in robot guidance by providing a better demarcation of a target area route or area for the robot to determine for placement. Another embodiment includes automotive environment, including both internal and/or external lighting.

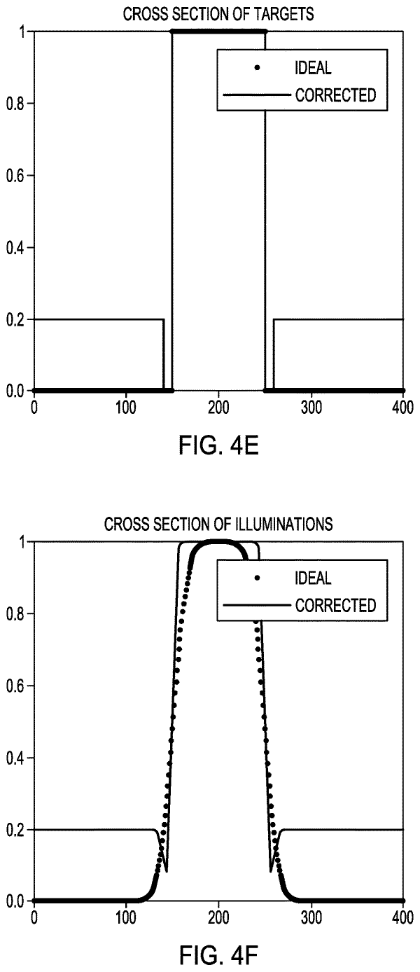

FIG. 5 illustrates an example lighting system, according to some embodiments. As above, some of the elements shown in the exemplary lighting system 500 may not be present, while other additional elements may be disposed in the lighting system 500. The lighting system 500 may include a controller 502 that controls illumination using one or more pixel arrays 510 that contains multiple individual pixels 512.

In some embodiments, some or all of the components described as the controller 502 may be disposed on a backplane such as, for example, a complementary metal oxide semiconductor (CMOS) backplane. The controller 502 may be coupled to or include one or more processors 504. The processor 504 may receive image data (in frames) via an interface and may process the image data to control a generator 506a, for example, controlling analog signals or PWM duty cycles and/or turn-on times for causing the lighting system 500 to produce the images indicated by the image data.

The generator 506a may be controlled by the processor 504 and may produce driving signals in accordance with the indications. The generator 506a may be connected to a driver 506b to drive the pixel array 510 so that the pixels 512 provide desired intensities of light.

Each pixel 512 may include one or more LEDs 514. The LEDs 514 may be different colors and may be controlled individually or in groups. As shown, the pixel 512 may include, for each pixel 512 or LED 514, a PWM switch, and a current source. The pixel 512 may be driven by the driver 506b. The signal from the generator 506a may cause the switch to open and close in accordance with the value of the signal. The signal corresponding to the intensities of light may cause the current source to produce a current flow to cause the pixels 512 to produce the corresponding intensities of light.

The lighting system 500 may further include a power supply 520. In some embodiments, the power supply 520 may be a battery that produces power for the controller 502.

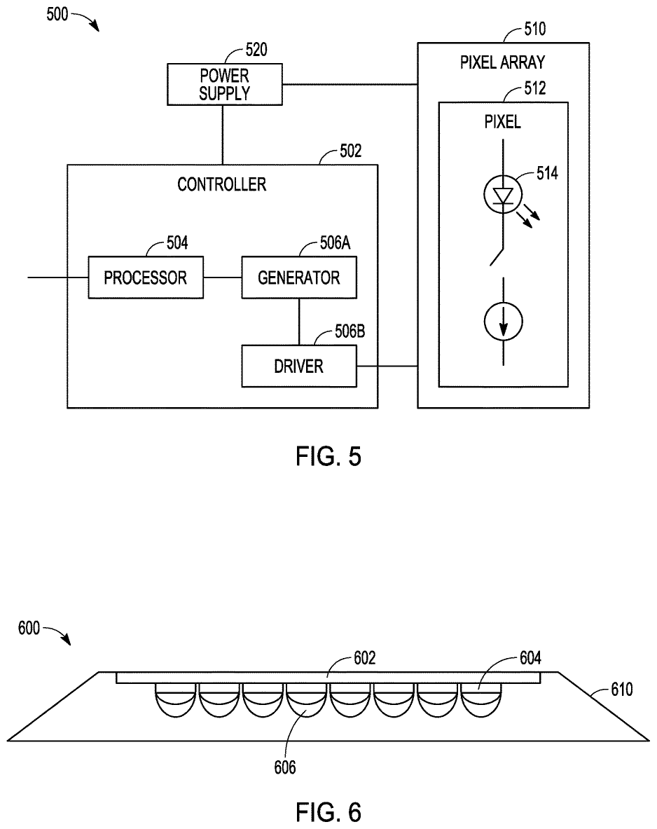

FIG. 6 illustrates an example lighting device 600, according to some embodiments. As above, some of the elements shown in the exemplary lighting device 600 may not be present, while other additional elements may be disposed in the lighting device 600. The lighting device 600 may include controller electronics 602, one or more LED arrays 604, and one or more optics 606 contained within a housing 610.

The controller electronics 602 may include, among others, one or more PCBs to control the LEDs of the one or more LED arrays 604, drivers to drive the LEDs using one or more channels, and WiFi or other communication modules to communicate with a remote controller. The controller electronics 602 may be disposed in one or more locations within the lighting device 600 and may be different from that shown in FIG. 6.

The LEDs and circuitry supporting the LED array can be packaged and include a submount or PCB for powering and controlling light production by the LEDs. The PCB supporting the LED array may include electrical vias, heat sinks, ground planes, electrical traces, and flip chip or other mounting systems. The submount or PCB may be formed of any suitable material, such as ceramic, silicon, aluminum, etc. If the submount material is conductive, an insulating layer may be formed over the substrate material, and a metal electrode pattern formed over the insulating layer for contact with the micro-LED array. The submount can act as a mechanical support, providing an electrical interface between electrodes on the LED array and a power supply, and also provide heat sink functionality.

The number of LED arrays 604 may vary from a single array up to a desired number able to be contained within the housing 610. The optics 606 may include lenses, reflective elements, and other devices that permit the light from the LEDs to be directed to a particular individual area. The shape of the housing 610 may be different from that shown in FIG. 6.

While only certain features of the system and method have been illustrated and described herein, many modifications and changes will occur to those skilled in the art. It is, therefore, to be understood that the appended claims are intended to cover all such modifications and changes. Method operations may be performed substantially simultaneously or in a different order.

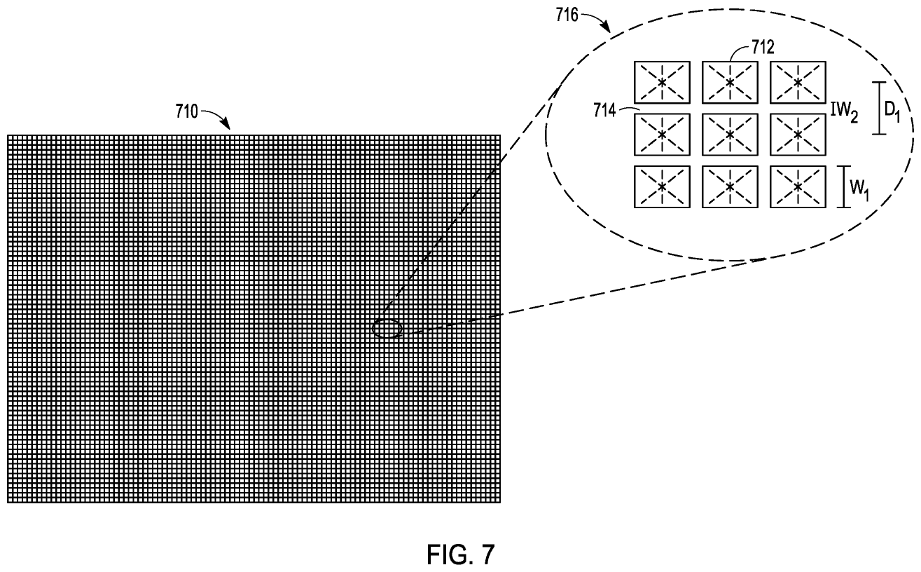

FIG. 7 illustrates a top plan view of an example array suitable for implementing embodiments described herein. The example hybridized device illustrated in FIG. 7 includes an LED die 710 that includes emitters (LEDs 712), such as those described herein. Projected patterned light may define images that may include light emitted from the LEDs 712. Each LED 712 (or group of LEDs) of the array may correspond to a projector picture element or projector pixel. In embodiments described herein, the LEDs 712. Suitable hybridized devices may include monolithic LED arrays, micro LED arrays, etc. Each LED 712 in LED die 710 may be individually addressable. Alternatively, groups or subsets of LEDs 712 may be addressable. In embodiments described herein, each array may comprise micro LEDs. Each LED 712 may have a size in the range of micrometers (i.e., between 1 micrometer (μm) and 100 μm). For example, LED 712 may have dimensions of approximately (within 10 μm by 10 μm) 40 μm by 40 μm in some embodiments. An LED 712 may have a lateral dimension of less than 100 μm in some embodiments.

LEDs 712 may be arranged as a matrix comprising one or more rows and one or more columns to define a rectangle. In other embodiments, LEDs 712 may be arranged to define other shapes. Each micro-LED included in the LED die 710 may encompass thousands or millions of projector pixels or LEDs. For example, an LED die 710 that contains a μLED may include within 5,000 pixels, 20,000 pixels or more-such as millions of pixels. Each pixel may include an emitter. An LED die 710 that contains the μLED can support high-density pixels having a lateral dimension less than 150 μm by 150 μm. In some embodiments, a μLED die can have dimensions of about 50 μm in diameter or width. In some embodiments, the height dimension of an array including the LEDs 712, their supporting substrate and electrical traces, and associated micro-optics may be less than 5 millimeters.

An exploded view of a 3×3 sub-array 716 of LEDs 712 included in LED die 710 is also shown in FIG. 7. Sub-array 716 may include LEDs 712, each defined by a width w1. In some example embodiments, width w1 can be approximately 100 μm or less (e.g., 40 μm). As shown in the sub-array 716, lanes 714 may be defined extending horizontally and vertically to define rows and columns of LEDs 712. Lanes 714 between the LEDs 712 may have a width, w2, wide. In some embodiments, the width w2 may be approximately 20 μm or less (e.g., 5 μm). In some embodiments, the width w2 may be as small as 1 μm. The lanes 714 may provide an air gap between adjacent emitters or may contain other material. A distance d1 from the center of one LED 712 to the center of an adjacent LED 712 may be approximately 120 μm or less (e.g., 45 μm). It will be understood that the widths and distances provided herein are examples of one of many possible embodiments in which widths and/or other dimensions may vary.

In some example embodiments, lanes 714 may be defined by a width w2 that can be approximately 20 μm or less (e.g., 5 μm). In some example embodiments, width w2 can be as small as 1 μm. Lanes 714 can serve to provide an air gap between adjacent LEDs 712 and may contain material other than light emitting material. In some example embodiments, a distance d1 from the center of one LED 712 to the center of an adjacent LED 712 can be approximately 120 μm or less (e.g., 45 μm). It will be understood that the LED and lane widths and distances between LEDs are intended as examples. Persons of ordinary skill reading the disclosure herein will appreciate a range of widths and/or dimensions will be suitable for various implementations, and those embodiments will fall within the scope of the disclosure.

For the convenience of illustration, LED 712 that are included in the LED die 710 are depicted herein as having a rectangular shape. However, as persons of ordinary skill will appreciate, a variety of other emitter shapes would be suitable for implementing the LED 712 and LED die 710 in various applications, and those would fall within the scope of the embodiments described herein. Likewise, LED die 710 is depicted in FIG. 7 as a symmetric matrix of LED 712. However, various other implementations of the LED die 710 may be suitable for implementing embodiments described herein, depending on application and design considerations. For example, in some implementations, LED die 710 can comprise a linear array of LED 712, and in other implementations a rectangular array of LED 712. In some implementations, the LED die 710 can comprise a symmetric or asymmetric matrix of LEDs 712. LED die 710 can comprise an array or matrix defined by a dimension or order that differs from the array dimensions or orders depicted herein.

For example, in some practical applications, the LED die 710 depicted in FIG. 7 may include over 20,000 LEDs 712 in asymmetric or symmetric arrangements in a wide range of array dimensions and orders (e.g., a 200×100 array, a symmetric matrix, or a non-symmetric matrix). For example, in some practical applications, two or more LED dies 710 can be stacked such that LEDs 712 are arranged to define rows and columns that extend in three spatial directions or dimensions. It will also be understood that the LED die 710 can itself be a subarray of a larger array (not shown) of LEDs 712.

LED die 710 may have a surface area of 90 mm² or greater and may require significant power to drive the array. In some applications, this power can be as much as 60 watts or more. The LED die 710 may include hundreds, thousands, or even millions of LEDs or emitters arranged within a centimeter-scale area substrate or smaller. A micro LED may include an array of individual emitters provided on a substrate or may be a single silicon wafer, or die partially or fully divided into light-emitting segments that form the LEDs 712. In some embodiments, the emitters may have distinct non-white colors. For example, at least four of the emitters may be RGBY groupings of emitters.

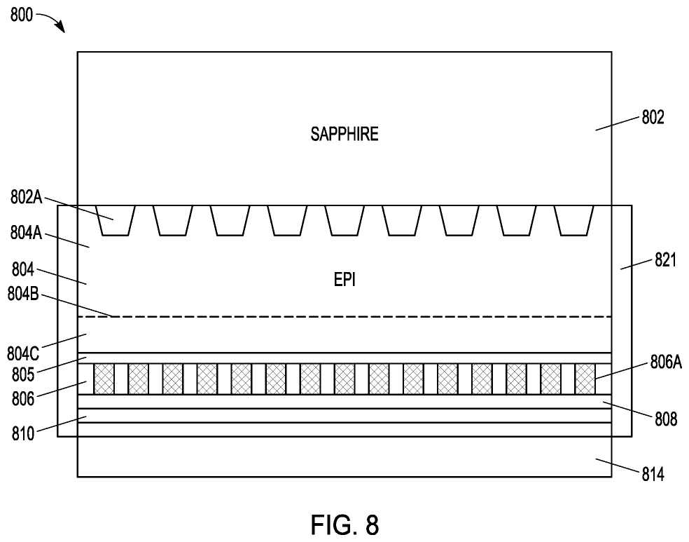

FIG. 8 illustrates a cross-section of an LED 800 in an LED array, in accordance with some examples. The LED 800 may be formed as or contained in a monolithic segmented device. The LED 800 may include multiple semiconductor layers grown on a substrate 802 (e.g., a sapphire substrate) that are to be fabricated into pixels 804. The substrate 802 may be any substrate, such as Sapphire, capable of having epitaxial layers grown thereon. The substrate 802 may have patterns 802a on which the epitaxial layers are grown. The pixels 804 may be formed from gallium nitride (GaN), having an n-type semiconductor 804a adjacent to the substrate 802, a p-type semiconductor 804c, and an active region 804b between the n-type semiconductor 804a and the p-type semiconductor 804c. The active region 804b may be, for example, a multiple quantum well structure in which light is generated for emission from the pixels 804. After processing, the substrate 802 may be removed in some embodiments.

Before etching of the epitaxial GaN layers, CSP die layers allowing uniform current distribution and optical coupling may be deposited. For example, uniform current injection in the p-type semiconductor 804c may be obtained by depositing a Transparent Conductive Oxide (TCO) layer 805 (such as an Indium Tin Oxide (ITO) layer) on the p-type semiconductor 804c.

To reduce Ag absorption losses, a dielectric spacer 806, such as SiO₂ or SiN and/or other dielectric material, is deposited or otherwise formed on the TCO layer 805. An array of openings is etched in a uniform distribution within the dielectric spacer 806 over the TCO layer 805 through lithographic processes (e.g., using a photoresist). A reflective layer 808 (or other optically reflective structure such as a Bragg reflector), such as an Ag mirror, may then be formed on the dielectric spacer 806. The material forming the reflective layer 808 may fill the openings in the dielectric spacer 806 to form eVias 806a and electrically connect the TCO layer 805 and the reflective layer 808. Thus, the eVias 806a may provide uniform current distribution over the area of the p-type semiconductor 804c. The dielectric spacer 806 may combine several different dielectrics to form a composite mirror to reduce light reflected by the Ag mirror and hence lower absorption losses by the Ag mirror. The addition of the composite mirror provides total internal reflection (TIR) at the SiO₂/GaN interface to enhance reflection and, as the Ag mirror is not in contact with the p-GaN, a transparent spreading current layer (the TCO layer) is used on the p-GaN.

A hard mask 810 is then deposited on the reflective layer 808. The hard mask 810 may be formed from a material substantially denser than a polymer, for example, SiO₂, SiC, or aluminum nitride (AlN). The hard mask 810 may have openings to allow current injection from the p-bonding layer (p-BL) to the reflective layer 808. The hard mask 810 may have openings to allow current injection from a p-bonding layer (p-BL) to the reflective layer 808 and thus the p-type semiconductor 804c, and from an n-bonding layer (n-BL) to the n-type semiconductor 804a.

The hard mask 810 is used to permit etching of a trench, as well as connections to the n-type semiconductor 804a. Note that although (wet or dry) etching is referred to, other techniques may be used to form various layers such as laser drilling, ion-beam formation, etc. To then insulate the pixels 804, one or more sidewall dielectric layers 812, such as SiO₂, may be deposited on the sidewalls of the pixel 804.

A bonding layer 814 may be disposed on the hard mask 810. The bonding layer 814 may be formed from copper (Cu) and/or Al, for example. In other embodiments, a single dielectric may be used to partially or completely fill the trench. In this case of a single dielectric layer, a conductive layer may be disposed on the single dielectric layer to promote reflection into the semiconductor layers. The trench may be on the order of several microns (e.g., up to about 10 microns), while the sidewall dielectric layers may be considerably thinner, e.g., up to about a few tenths of a micron. The thickness of the sidewall dielectric layers may be dependent on the desired index of refraction created by the structure.

FIG. 8 shows only one example of an LED structure. Other layers may be present but are not shown for convenience.

### EXAMPLES

Example 1 is an illumination system comprising: at least one light source configured to provide illumination over a predetermined area, the at least one light source comprising at least one light emitting diode (LED) array, the at least one LED array having a plurality of LEDs; and a controller comprising at least one processor configured to: select an illumination pattern of the at least one light source, the illumination pattern including a target area, determine at least one portion of the illumination pattern to be used in contrast enhancement, the at least one portion of the illumination pattern adjacent to the target area, and adjust parameters used to provide the at least one portion of the illumination pattern to increase contrast between the at least one portion of the illumination pattern and the target area.

In Example 2, the subject matter of Example 1 includes, wherein, to adjust the parameters, the at least one processor is configured to adjust current used to drive a set of the LEDs configured to provide the at least one portion of the illumination pattern.

In Example 3, the subject matter of Examples 1-2 includes, wherein: driving of the illumination pattern is based on a matrix of elements that are to control an intensity of illumination from each LED, and to adjust the parameters, the at least one processor is configured to apply a filter mask to apply a two-dimensional (2D) convolution to the matrix of elements.

In Example 4, the subject matter of Example 3 includes, wherein dimensions of the matrix of elements and dimensions of a matrix of the filter mask are different.

In Example 5, the subject matter of Examples 1~4 includes, wherein the at least one processor is configured to control driving of LEDs associated with a first background area of the illumination pattern to provide a non-zero current to the LEDs associated with the first background area prior to adjustment of the parameters, the first background area comprising the illumination pattern other than the target area, the non-zero current being substantially less than current used to drive LEDs associated with the target area.

In Example 6, the subject matter of Example 5 includes, wherein, after adjustment of the parameters, the at least one processor is configured to control driving of LEDs associated with a second background area of the illumination pattern to provide the non-zero current to the LEDs associated with the second background area and to provide zero current to LEDs associated with the at least one portion of the illumination pattern.

In Example 7, the subject matter of Example 6 includes, wherein the first background area is to be formed from the second background area and the at least one portion of the illumination pattern.

In Example 8, the subject matter of Examples 6-7 includes, wherein the at least one portion of the illumination pattern is to be disposed between the second background area and the target area.

In Example 9, the subject matter of Examples 1-8 includes, wherein the at least one light source includes at least one luminaire.

In Example 10, the subject matter of Examples 1-9 includes, wherein the at least one light source is disposed within a vehicle.

In Example 11, the subject matter of Examples 1-10 includes, wherein the LEDs are microLEDs.

In Example 12, the subject matter of Examples 1-11 includes, wherein the controller is configured to control drivers in the at least one light source to provide the illumination pattern.

In Example 13, the subject matter of Examples 1-12 includes, a user interface configured to wirelessly control the controller to set the illumination pattern.

Example 14 is an illumination device comprising: at least one light emitting diode (LED) array configured to provide illumination over a predetermined area, the at least one LED array having a plurality of LEDs; and a controller comprising at least one processor configured to: select an illumination pattern of the at least one LED array, the illumination pattern including a target area, determine at least one portion of the illumination pattern to be used in contrast enhancement, the at least one portion of the illumination pattern adjacent to the target area, and adjust parameters used to provide the at least one portion of the illumination pattern to increase contrast between the at least one portion of the illumination pattern and the target area.

In Example 15, the subject matter of Example 14 includes, wherein, to adjust the parameters, the at least one processor is configured to adjust current used to drive a set of the LEDs configured to provide the at least one portion of the illumination pattern.

In Example 16, the subject matter of Examples 14-15 includes, wherein: driving of the illumination pattern is based on a matrix of elements that are to control an intensity of illumination from each LED, and to adjust the parameters, the at least one processor is configured to apply a filter mask to apply a two dimensional (2D) convolution to the matrix of elements.

In Example 17, the subject matter of Example 16 includes, wherein dimensions of the matrix of elements and dimensions of a matrix of the filter mask are different.

In Example 18, the subject matter of Examples 14-17 includes, wherein the at least one processor is configured to control driving of LEDs associated with a first background area of the illumination pattern to provide a non-zero current to the LEDs associated with the first background area prior to adjustment of the parameters, the first background area comprising the illumination pattern other than the target area, the non-zero current being substantially less than current used to drive LEDs associated with the target area.

In Example 19, the subject matter of Example 18 includes, wherein, after adjustment of the parameters, the at least one processor is configured to control driving of LEDs associated with a second background area of the illumination pattern to provide the non-zero current to the LEDs associated with the second background area and to provide zero current to LEDs associated with the at least one portion of the illumination pattern.

In Example 20, the subject matter of Example 19 includes, wherein the first background area is to be formed from the second background area and the at least one portion of the illumination pattern.

In Example 21, the subject matter of Examples 19-20 includes, wherein the at least one portion of the illumination pattern is to be disposed between the second background area and the target area.

In Example 22, the subject matter of Examples 14-21 includes, wherein the illumination device comprises at least one luminaire.

In Example 23, the subject matter of Examples 14-22 includes, wherein the illumination device is disposed within a vehicle.

In Example 24, the subject matter of Examples 14-23 includes, wherein the LEDs are microLEDs.

In Example 25, the subject matter of Examples 14-24 includes, wherein the controller is configured to control drivers to provide the illumination pattern.

Example 26 is a method of operating an illumination device, the method comprising: providing illumination over a predetermined area using at least one light emitting diode (LED) array, the at least one LED array having a plurality of LEDs; selecting an illumination pattern of the at least one LED array, the illumination pattern including a target area, determining at least one portion of the illumination pattern to be used in contrast enhancement, the at least one portion of the illumination pattern adjacent to the target area, and adjusting parameters used to provide the at least one portion of the illumination pattern to increase contrast between the at least one portion of the illumination pattern and the target area.

In Example 27, the subject matter of Example 26 includes, wherein adjusting the parameters comprises adjusting current used to drive a set of the LEDs configured to provide the at least one portion of the illumination pattern.

In Example 28, the subject matter of Examples 26-27 includes, wherein: driving the illumination pattern is based on a matrix of elements that are to control an intensity of illumination from each LED, and adjusting the parameters comprises applying a filter mask to apply a two dimensional (2D) convolution to the matrix of elements.

In Example 29, the subject matter of Example 28 includes, wherein dimensions of the matrix of elements and dimensions of a matrix of the filter mask are different.

In Example 30, the subject matter of Examples 26-29 includes, wherein, before adjusting the parameters, driving LEDs associated with a first background area of the illumination pattern to provide a non-zero current to the LEDs associated with the first background area, the first background area comprising the illumination pattern other than the target area, the non-zero current being substantially less than current used to drive LEDs associated with the target area.

In Example 31, the subject matter of Example 30 includes, wherein, after adjusting the parameters, driving LEDs associated with a second background area of the illumination pattern to provide the non-zero current to the LEDs associated with the second background area and to provide zero current to LEDs associated with the at least one portion of the illumination pattern.

In Example 32, the subject matter of Example 31 includes, wherein the first background area is to be formed from the second background area and the at least one portion of the illumination pattern.

In Example 33, the subject matter of Examples 31-32 includes, wherein the at least one portion of the illumination pattern is to be disposed between the second background area and the target area.

Example 34 is at least one machine-readable medium including instructions that, when executed by processing circuitry, cause the processing circuitry to perform operations to implement of any of Examples 1-33.

Example 35 is an apparatus comprising means to implement of any of Examples 1-33.

Example 36 is a system to implement of any of Examples 1-33.

Example 37 is a method to implement of any of Examples 1-33.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. An illumination system comprising:
at least one light source configured to provide illumination over a predetermined area, the at least one light source comprising at least one light emitting diode (LED) array, the at least one LED array having a plurality of LEDs; and
a controller comprising at least one processor configured to:
select an illumination pattern of the at least one light source, the illumination pattern including a target area,
determine at least one portion of the illumination pattern to be used in contrast enhancement, the at least one portion of the illumination pattern adjacent to the target area, and
adjust parameters used to provide the at least one portion of the illumination pattern to increase contrast between the at least one portion of the illumination pattern and the target area,
wherein the at least one processor is configured to control driving of LEDs associated with a first background area of the illumination pattern to provide a non-zero current to the LEDs associated with the first background area prior to adjustment of the parameters, the first background area comprising an area of the illumination pattern other than the target area, the non-zero current being substantially less than current used to drive LEDs associated with the target area, and
wherein, after adjustment of the parameters, the at least one processor is configured to control driving of LEDs associated with a second background area of the illumination pattern to provide the non-zero current to the LEDs associated with the second background area and to provide zero current to LEDs associated with the at least one portion of the illumination pattern.

2. The illumination system of claim 1, wherein, to adjust the parameters, the at least one processor is configured to adjust current used to drive a set of the LEDs configured to provide the at least one portion of the illumination pattern.

3. The illumination system of claim 1 or 2, wherein:
driving of the illumination pattern is based on a matrix of elements that are configured to control an intensity of illumination from each LED, and
to adjust the parameters, the at least one processor is configured to apply a filter mask to apply a two-dimensional (2D) convolution to the matrix of elements.

4. The illumination system of claim 3, wherein dimensions of the matrix of elements and dimensions of a matrix of the filter mask are different.

5-6. (canceled)

7. The illumination system of claim 1, wherein the first background area is to be formed from the second background area and the at least one portion of the illumination pattern.

8. The illumination system of claim 1, wherein the at least one portion of the illumination pattern is to be disposed between the second background area and the target area.

9. The illumination system of claim 1, wherein the at least one light source is disposed within a vehicle.

10. The illumination system of claim 1, wherein at least one of:
the controller is configured to control drivers in the at least one light source to provide the illumination pattern, or
a user interface is configured to wirelessly control the controller to set the illumination pattern.

11. An illumination device comprising:
at least one light emitting diode (LED) array configured to provide illumination over a predetermined area, the at least one LED array having a plurality of LEDs; and
a controller comprising at least one processor configured to:
select an illumination pattern of the at least one LED array, the illumination pattern including a target area,
determine at least one portion of the illumination pattern to be used in contrast enhancement, the at least one portion of the illumination pattern adjacent to the target area, and
adjust parameters used to provide the at least one portion of the illumination pattern to increase contrast between the at least one portion of the illumination pattern and the target area,
wherein the at least one processor is configured to control driving of LEDs associated with a first background area of the illumination pattern to provide a non-zero current to the LEDs associated with the first background area prior to adjustment of the parameters, the first background area comprising an area of the illumination pattern other than the target area, the non-zero current being substantially less than current used to drive LEDs associated with the target area, and
wherein, after adjustment of the parameters, the at least one processor is configured to control driving of LEDs associated with a second background area of the illumination pattern to provide the non-zero current to the LEDs associated with the second background area and to provide zero current to LEDs associated with the at least one portion of the illumination pattern.

12. The illumination device of claim 11, wherein, to adjust the parameters, the at least one processor is configured to adjust current used to drive a set of the LEDs configured to provide the at least one portion of the illumination pattern.

13. The illumination device of claim 11 or 12, wherein:
driving of the illumination pattern is based on a matrix of elements that are to control an intensity of illumination from each LED, and
to adjust the parameters, the at least one processor is configured to apply a filter mask to apply a two dimensional (2D) convolution to the matrix of elements.

14-15. (canceled)

16. The illumination device of claim 11, wherein the first background area is to be formed from the second background area and the at least one portion of the illumination pattern.

17. The illumination device of claim 11, wherein the at least one portion of the illumination pattern is to be disposed between the second background area and the target area.

18. A method of operating an illumination device, the method comprising:
providing illumination over a predetermined area using at least one light emitting diode (LED) array, the at least one LED array having a plurality of LEDs;
selecting an illumination pattern of the at least one LED array, the illumination pattern including a target area,
determining at least one portion of the illumination pattern to be used in contrast enhancement, the at least one portion of the illumination pattern adjacent to the target area, and
adjusting parameters used to provide the at least one portion of the illumination pattern to increase contrast between the at least one portion of the illumination pattern and the target area,
wherein before adjusting the parameters, driving LEDs associated with a first background area of the illumination pattern to provide a non-zero current to the LEDs associated with the first background area, the first background area comprising the illumination pattern other than the target area, the non-zero current being substantially less than current used to drive LEDs associated with the target area, and
after adjusting the parameters, driving LEDs associated with a second background area of the illumination pattern to provide the non-zero current to the LEDs associated with the second background area and to provide zero current to LEDs associated with the at least one portion of the illumination pattern.

19. The method of claim 18, wherein:
driving the illumination pattern is based on a matrix of elements that are to control an intensity of illumination from each LED, and
adjusting the parameters comprises applying a filter mask to apply a two dimensional (2D) convolution to the matrix of elements.

20. (canceled)
